(19) United States
(12) Patent Application Publication
(10) Pub. No.: US 2018/0218369 A1
(43) Pub. Date: Aug. 2, 2018

(54) DETECTING FRAUDULENT DATA

(71) Applicant: GOOGLE INC., Mountain View, CA (US)

(72) Inventors: Bingjun Xiao, San Mateo, CA (US); Yuxing Zhang, Pittsburgh, PA (US); Haichun Chen, Sunnyvale, CA (US)

(21) Appl. No.: 15/422,410

(22) Filed: Feb. 1, 2017

(51) Int. Cl. G06Q 20/40

(52) U.S. Cl. CPC G06Q 20/4016

(57) ABSTRACT

A processing system processes transactions between users and merchant systems. The processing system extracts, for a group of transactions, features from each user transaction and generates, for each feature, a feature vector representing each transaction of the group of transactions. The processing system computes, for each feature vector shared between transactions, a similarity between each transaction and all other transactions of the group of transactions. The processing system clusters the transactions represented by the feature vectors via a hierarchical clustering algorithm based on the similarity values. The processing system, for each cluster of transactions, determines a volume of the cluster over time. For each cluster, the payment processing system determines whether the change in the volume of the cluster over time is anomalous or normal. If a cluster experienced anomalous growth, the payment processing system identifies the cluster as a potential new fraudulent transaction pattern.

### TECHNICAL FIELD

The present disclosure relates to detecting new fraudulent transaction patterns, and particularly to determining new fraudulent transaction patterns by clustering transactions based on transaction features and monitoring the volume of clusters over time for anomalous cluster growth.

### BACKGROUND

Conventional fraud detection systems monitor countless transactions for various products and services. Such systems are interested in detecting fraudulent transactions, which result in loss. Often, fraudsters use stolen credit cards or other illegally obtained instruments or transfer funds to their own bank accounts using online payment systems. The fraud detection system may be responsible for these fraudulent charges if they are not detected and stopped. Therefore, detecting and stopping fraudulent transactions is desirable to reduce losses incurred by fraud detection systems.

In conventional technology, fraud detection systems use supervised machine learning algorithms based on a history of transactions that are marked as fraudulent or not fraudulent to train the machine learning algorithms. Fraudulent transactions are identified using known, fixed patterns of fraud that determine that transactions are fraudulent if they include certain known aspects. However, conventional methods to detect fraudulent transactions require human analysts to determine new fraud patterns after those fraud patterns have been established and utilized by fraudsters for a period of time, perhaps months. Further, conventional methods to detect fraudulent transactions may rely on a history for individual user accounts and calculate a probability of a fraudulent transaction for an individual account based on a transaction history of the individual user account. However, fraudsters can easily register new user accounts, preventing fraud detection systems from having a reference to an account history for new accounts.

### SUMMARY

Techniques herein provide computer-implemented methods to detect fraud. In an example, merchant systems and users register and account with a payment processing system. Each user downloads a payment application onto the respective user computing device. Users conduct transactions with a website of the merchant system or at a physical location of the merchant system with a merchant system point of sale device. A user conducting a transaction with the merchant system indicates payment via the payment application and selects a particular payment account for use in the payment transaction. The payment processing system processes the transaction and stores the transaction data associated with the payment transaction. The payment processing system extracts, for a group of transactions, features from each user transaction and generates, for each feature, a feature vector representing each transaction of the group of transactions. The payment processing system computes, for each feature vector shared between transactions, a similarity between each transaction and all other transactions of the group of transactions. The payment processing system clusters the transactions represented by the feature vectors via a hierarchical clustering algorithm based on the similarity values. The payment processing system, for each cluster of transactions, determines a volume of the cluster over time. For each cluster, the payment processing system determines whether the change in the volume of the cluster over time is anomalous or normal. For each cluster, if the cluster experienced anomalous growth, the payment processing system identifies the cluster as a potential new fraudulent transaction pattern. For each cluster, if the cluster did not experience anomalous growth, the payment processing system identifies the cluster as a non-fraudulent transaction pattern. The payment processing system receives new transaction data at a subsequent time and performs the method for clustering transactions based on features and determining anomalous cluster growth.

In certain other example aspects described herein, systems and computer program products to detect fraud are provided.

These and other aspects, objects, features, and advantages of the examples will become apparent to those having ordinary skill in the art upon consideration of the following detailed description of illustrated examples.

### BRIEF DESCRIPTION OF THE DRAWINGS

FIG. 1 is a block diagram depicting a system for monitoring for anomalous cluster growth in transaction data to detect new fraudulent transaction patterns, in accordance with certain examples.

FIG. 2 is a block flow diagram depicting a method for monitoring for anomalous cluster growth in transaction data to detect new fraudulent transaction patterns, in accordance with certain examples.

FIG. 3 is a block flow diagram depicting a method for registering, by a user, for an account with a payment processing system, in accordance with certain examples.

FIG. 4 is a block flow diagram depicting a method for conducting, by a user, a transaction on a merchant system website, in accordance with certain examples.

FIG. 5 is a block flow diagram depicting a method for clustering, by a payment processing system, transactions based on features and identifying new fraudulent patterns exhibited by clusters having anomalous growth over time, in accordance with certain examples.

FIG. 6 is a block diagram depicting a computing machine and module, in accordance with certain examples.

### DETAILED DESCRIPTION OF EXAMPLES

### Overview

The examples described herein provide computer-implemented techniques for monitoring for anomalous cluster growth in transaction data to detect new fraudulent transaction patterns.

In an example, merchant systems register with a payment processing system. Users register with the payment processing system. Each user registers with the payment processing system by accessing, via a respective user computing device, a payment processing system website, registering with the payment processing system via the payment processing system website, and downloads a payment application onto the respective user computing device. Each user enters payment account information into his user account using the payment application and configures permissions and settings associated with the user account using the payment application. Users conduct transactions, using the user computing device, with a website of the merchant system or at a physical location of the merchant system with a merchant system point of sale device. A user conducting a transaction with the merchant system indicates payment via the payment application and selects a particular payment account for use in the payment transaction. The payment processing system processes the transaction and stores the transaction data associated with the payment transaction. The payment processing system extracts, for a group of transactions, features from each user transaction and generates, for each feature, a feature vector representing each transaction of the group of transactions. The payment processing system computes, for each feature vector shared between transactions, a similarity between each transaction and all other transactions of the group of transactions. The payment processing system clusters the transactions represented by the feature vectors via a hierarchical clustering algorithm based on the similarity values. The payment processing system, for each cluster of transactions, determines a volume of the cluster over time. For each cluster, the payment processing system determines whether the change in the volume of the cluster over time is anomalous or normal. For each cluster, if the cluster experienced anomalous growth, the payment processing system identifies the cluster as a potential new fraudulent transaction pattern. For each cluster, if the cluster did not experience anomalous growth, the payment processing system identifies the cluster as a non-fraudulent transaction pattern. The payment processing system receives new transaction data at a subsequent time and performs the method for clustering transactions based on features and determining anomalous cluster growth.

Merchant systems register with a payment processing system. For example, one or more merchant systems register a respective merchant system website with the payment processing system. For example, the merchant system website comprises a shopping website where users may purchase products or services. In another example, one or more merchant systems register with the payment processing system and install a payment application on a respective merchant system point of sale device at a respective merchant system location. In an example, users register with the payment processing system. For example, each user accesses a payment processing system website via a user computing device associated with the respective user and registers a user account with the payment processing system. The respective user downloads a payment application onto the user computing device and enters payment account information into the user account using the payment application. Users may configure permissions and settings associated with the user account using the payment application.

One or more users conduct payment transactions on the merchant system website. In an example transaction, a user accesses the merchant system website via the user computing device associated with the user. The user adds one or more items to a virtual shopping cart and selects an option to check out. The merchant website displays a request for the user to select a payment option and the user indicates a desire to pay via the payment application. The user selects a particular payment account to use via the payment application and confirms the payment transaction. The payment processing system processes the transaction using the selected particular payment account and the user receives a receipt on the user computing device from the merchant system website and/or from the payment processing system. For example, the merchant system website generates a transaction identifier and transmits transaction details to the payment processing system. The payment processing system receives the transaction details and processes the transaction using the received transaction details.

In another example, one or more users conduct transactions at one or more merchant system point of sale devices at a corresponding one or more merchant system locations. In an example transaction, the user arrives at the merchant system point of sale device. The merchant computing device operator totals items of the user for purchase. The merchant system point of sale device operator asks the user to select a payment option. The user indicates a desire to pay via the payment application. In an example, the user computing device is paired to the merchant system point of sale device via a wireless communication channel and a transaction is processed. For example, the wireless communication channel comprises a near-field communication (“NFC”) channel, a Bluetooth communication channel, a Bluetooth low-energy communication channel, or a Wi-Fi communication channel. The merchant system point of sale device operator selects the payment application on the merchant system point of sale device to initiate a transaction. The merchant system point of sale device transmits transaction details to a payment processing system. The payment processing system receives the transaction details and processes the transaction using the received transaction details. The user receives a receipt from the payment processing system and/or the merchant system website on the user computing device.

The payment processing system stores transaction data for payment transactions of users. The payment processing system extracts, for a group of transactions, features from each transaction and generates, for each feature, a feature vector for each transaction of the group of transactions. The payment processing system computes, based on each feature vector shared between transactions, a similarity between each transaction to all other transactions of the group of transactions. The payment processing system clusters the group of transactions represented by feature vectors via a hierarchical clustering algorithm based on the computed similarity values for each feature. The payment processing system, for each cluster of transactions, determines a volume of the cluster over time. For each cluster, the payment processing system determines whether the change in the volume of the cluster over time is anomalous or normal. If a particular cluster experienced anomalous growth over time, the payment processing system identifies the particular cluster as a potentially new fraudulent transaction pattern. In another example, if the particular cluster did not experience anomalous growth over time, the payment processing system identifies the particular cluster as a non-fraudulent transaction pattern. The payment processing system receives new transaction data and performs the method for clustering transactions based on features and determining anomalous cluster growth.

By using and relying on the methods and systems described herein, the payment processing system is able to quickly identify new fraudulent transaction patterns via applying a hierarchical clustering algorithm to transaction data represented by feature vectors and monitoring individual transaction clusters for anomalous growth over time. As such, the systems and methods described herein may identify characteristic features associated with new potential fraudulent transaction patterns that have not been previously identified. By using and relying on the methods and systems described herein, systems, such as application distribution systems, e-mail distribution systems, account management systems, or other systems where fraudsters can potentially scale up their abuse of systems via automation software, device emulators, or temporarily hiring people to repeat the abuse pattern, are able to quickly identify new fraudulent patterns (for example, fraudulent application review patterns, fraudulent e-mail patterns such as “spam” or “junk” mail patterns, or fraudulent login attempts) by applying a hierarchical clustering algorithm to data represented by feature vectors and monitoring individual clusters for anomalous growth over time. As such, the systems and methods described herein may identify characteristic features associated with new potential fraudulent patterns that have not been previously identified.

### Example System Architecture

Turning now to the drawings, in which like numerals indicate like (but not necessarily identical) elements throughout the figures, examples are described in detail.

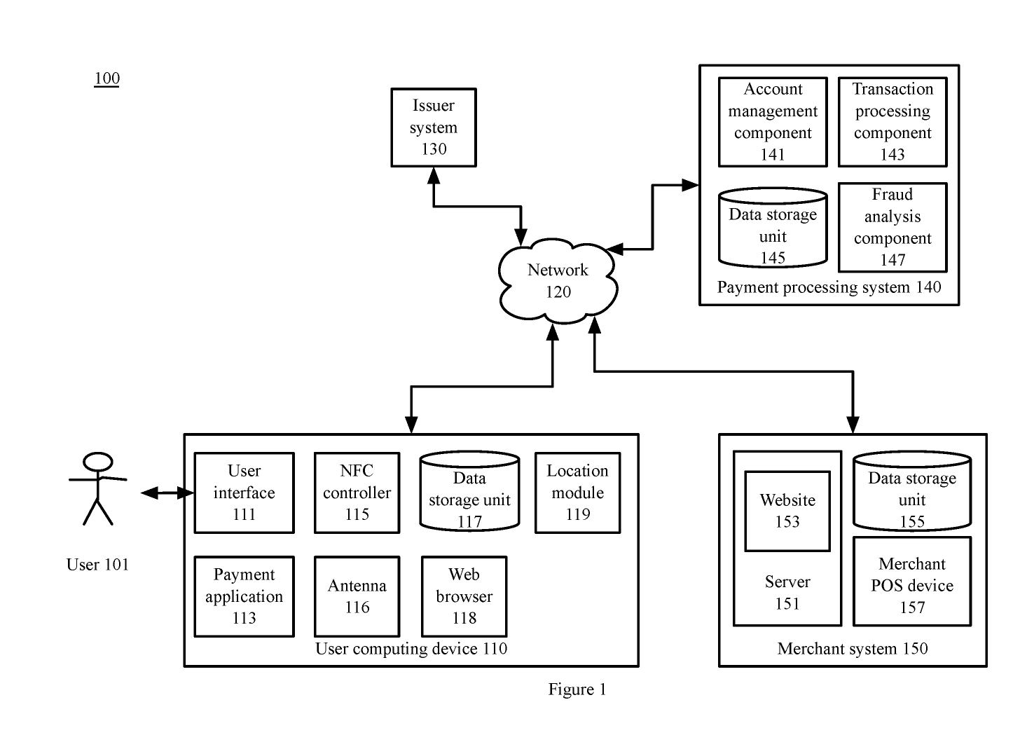

FIG. 1 is a block diagram depicting a system 100 for monitoring for anomalous cluster growth in transaction data to detect new fraudulent transaction patterns, in accordance with certain examples. As depicted in FIG. 1, the system 100 includes network computing devices 110, 130, 140, 150, and 157 that are configured to communicate with one another via one or more networks 120. In some embodiments, a user associated with a device must install an application and/or make a feature selection to obtain the benefits of the techniques described herein.

In examples, the network 120 can include a local area network (“LAN”), a wide area network (“WAN”), an intranet, an Internet, storage area network (“SAN”), personal area network (“PAN”), a metropolitan area network (“MAN”), a wireless local area network (“WLAN”), a virtual private network (“VPN”), a cellular or other mobile communication network, Bluetooth, Bluetooth low energy (“BLE”), near field communication (“NFC”), ultrasound communication, or any combination thereof or any other appropriate architecture or system that facilitates the communication of signals, data, and/or messages. Throughout the discussion of examples, it should be understood that the terms “data” and “information” are used interchangeably herein to refer to text, images, audio, video, or any other form of information that can exist in a computer-based environment.

Each network computing device 110, 130, 140, 150, and 157 includes a device having a communication module capable of transmitting and receiving data over the network 120. For example, each network computing device 110, 130, 140, and 150 can include a server, desktop computer, laptop computer, tablet computer, a television with one or more processors embedded therein and / or coupled thereto, smart phone, handheld computer, personal digital assistant (“PDA”), or any other wired or wireless, processor-driven device. In the example depicted in FIG. 1, the network computing devices 110, 130, 140, 150, and 157 are operated by users 101, issuer system 130 operators, payment processing system 140 operators, merchant system 150 operators, and merchant system point of sale (“POS”) device 157 operators, respectively.

In the examples described herein, the payment processing system 140 processes and receives transaction data associated with transactions between multiple merchant systems 150 and user computing devices 110 associated with respective users 101.

An example user computing device 110 comprises a user interface 111, a payment application 113, a near-field communication (“NFC”) controller 115, an antenna 116, a data storage unit 117, a web browser 118, and a location module 119.

In an example, the user interface 111 enables the user 101 to interact with the user computing device 110. For example, the user interface 111 may be a touch screen, a voice-based interface, or any other interface that allows the user 101 to provide input and receive output from an application on the user computing device 110. In an example, the user 101 interacts via the user interface 111 with the payment application 113. In an example, the user 101 interacts with a merchant system website 153 using a web browser 118 application on the user computing device 110 via the user interface 111.

In an example, the payment application 113 is a program, function, routine, applet, or similar entity that exists on and performs its operations on the user computing device 110. In certain examples, the user 101 must install the payment application 113 and/or make a feature selection on the user computing device 110 to obtain the benefits of the techniques described herein. In an example, the user 101 may access the payment application 113 on the user computing device 110 via the user interface 111. In an example, the payment application 113 may be associated with the payment processing system 140.

In an example, the NFC controller 115 is capable of sending and receiving data, performing authentication and ciphering functions, and directing how the user computing device 110 will listen for transmissions from the merchant system POS device 157 or configuring the user computing device 110 into various power-save modes according to NFC-specified procedures. In another example, the user computing device 110 comprises a Bluetooth controller, Bluetooth low energy (“BLE”) controller, or a Wi-Fi controller capable of performing similar functions. An example NFC controller 115 communicates with the payment application 113 and is capable of sending and receiving data over a wireless, NFC communication channel. In another example, a Bluetooth controller, BLE controller, or Wi-Fi controller performs similar functions as the NFC controller 115 using Bluetooth, BLE, or Wi-Fi communication protocols. In an example, the NFC controller 115 activates an antenna 116 to create a wireless communication channel between the user computing device 110 and the merchant system POS device 157. For example, the user computing device 110 communicates with the merchant system POS device 157 via the antenna 116. In an example, when the user computing device 110 has been activated, the NFC controller 115 polls through the antenna 116 a radio signal, or listens for radio signals from the merchant system POS device 157.

In an example, the antenna 116 is a means of communication between the user computing device 110 and a merchant system POS device 157. In an example, an NFC controller 115 outputs through the antenna 116 a radio signal, or listens for radio signals from the merchant POS device 157. In another example a Bluetooth controller, BLE controller, or a Wi-Fi controller outputs through the antenna 116 the radio signal, or listens for radio signals from the merchant system POS device 157 instead of the NFC controller 115.

In an example, the data storage unit 117 comprises a local or remote data storage structure accessible to the user computing device 110 suitable for storing information. In an example, the data storage unit 117 stores encrypted information, such as HTML5 local storage.

In an example, the user 101 can use a communication application, such as a web browser 118, to view, download, upload, or otherwise access documents or web pages via a distributed network 120. In an example, the user 101 accesses the merchant system website 153 over the network 120 via the web browser 118. In another example, the user 101 accesses the merchant system website 153 via a merchant system 150 shopping application resident on the user computing device 110. In an example, the user 101 accesses a website of the payment processing system 140 via the web browser 118. In another example, the user 101 accesses the website of the payment processing system 140 or otherwise interacts with the payment processing system 140 via the payment application 113.

In an example, the location determination component 119 is capable of receiving an input from the global positioning system (“GPS”) or other satellite-based positioning system. In an example, the location determination component 119 is able to log the approximate longitude and latitude of the user computing device 110. In another example, the location determination component 119 calculates a distance of the user computing device 110 from the nearest radio towers or cell towers to determine a location of the user computing device 110. In yet another example, the location determination module 119 determines the location of the user computing device 110 when a network 120 connection is established with a merchant system POS device 157 or other device having a known location. In an example, the user 101 configures one or more settings on the user computing device 110 and/or the payment application 113 to give permission for the location determination component 119 to log the location of the user computing device 110 and transmit the location to the payment processing system 140. In an example, the user 101 configures one or more settings on the user computing device 110 and/or payment application 113 to revoke permission or prevent the location determination module 119 from logging the location of the user computing device 110 and/or transmitting the location of the user computing device 110 to the payment processing system 140.

An example issuer system 130 approves or denies a payment authorization request received from the payment processing system 140. In an example, the issuer system 130 communicates with the payment processing system 140 over the network 120. In an example, the issuer system 130 communicates with an acquirer system to approve a credit authorization and to make payment to the payment processing system 140 and/or merchant system. For example, the acquirer system is a third party payment processing company.

An example payment processing system 140 comprises an account management component 141, a transaction processing component 143, a data storage unit 145, and a fraud analysis component 147.

In an example, the account management component 141 manages user 101 accounts and merchant system 150 accounts associated with one or more users 101 and one or more merchant systems 150, respectively. The account management component 141 may receive requests to add, edit, delete, or otherwise modify payment account information for a user 101 account or a merchant system 150 account.

In an example, the transaction processing component 143 receives transaction details from a merchant system POS device 157 and payment information associated with a user 101 payment account. In an example, the transaction processing component 143 transmits a payment authorization request to an issuer system 130 or other appropriate financial institution associated with the user 101 payment account information. An example payment authorization request may comprise merchant system 150 payment account information, user 101 payment account information, and a total amount of the transaction. In an example, after the issuer system 130 processes the payment authorization request, the transaction processing component 143 receives an approval or denial of the payment authorization request from the issuer system 130 over the network 120. In an example, the transaction processing component 143 transmits a receipt to the merchant system POS device 157 and/or the user computing device 110 comprising a summary of the payment transaction.

In an example, for each transaction processed by the payment processing system 140, the transaction processing component 143 receives and/or logs transaction details from the merchant system website 153 or the merchant system POS device 157. For example, the transaction details comprise one or more of a total amount of the transaction, an age of the user 101 payment processing system 140 account used in the transaction, a type of payment instrument used in the transaction, a date of the most recent transaction approved prior to the transaction, an amount spent over a period of time by the user 101, and a distance between a device of the merchant system 150 (for example, the merchant system server 151 or merchant system POS device 157) used in the transaction and a device of the user 101 used in the transaction.

In an example, the data storage unit 145 comprises a local or remote data storage structure accessible to the payment processing system 140 suitable for storing information. In an example, the data storage unit 145 stores encrypted information, such as HTML5 local storage.

In an example, the fraud analysis component 147 extracts, for a group of transactions, features from each user transaction and generates, for each feature, a feature vector representing each transaction of the group of transactions. The fraud analysis component 147 may compute, for each feature vector shared between transactions, a similarity between each transaction and all other transactions of the group of transactions. The fraud analysis component 147 may cluster the transactions represented by the feature vectors via a hierarchical clustering algorithm based on the similarity values. The fraud analysis component 147, for each cluster of transactions, may determine a volume of the cluster over time. For each cluster, the fraud analysis component 147 may determine whether the change in the volume of the cluster over time is anomalous or normal. For each cluster, if the cluster experienced anomalous growth, the fraud analysis component 147 may identify the cluster as a potential new fraudulent transaction pattern. For each cluster, if the cluster did not experience anomalous growth, the fraud analysis component 147 may identify the cluster as a non-fraudulent transaction pattern. The fraud analysis component 147 may receive new transaction data at a subsequent time and performs the method for clustering transactions based on features and determining anomalous cluster growth.

In the examples described herein, the payment processing system 140 processes and receives transaction data associated with transactions between multiple merchant systems 150 and user computing devices 110 associated with respective users 101.

An example merchant system 150 comprises a server 151, a website 153, a data storage unit 155, and a merchant point of sale (“POS”) device 157.

In an example, the server 151 provides the content that the user 101 accesses through the web browser 118 on the user computing device 110, including but not limited to html documents, images, style sheets, and scripts. In an example, the web server 151 supports the website 153 of the merchant system 150.

In an example, the website 153 communicates with the web browser 118 or a shopping application resident on the user computing device 110 via the network 120. In an example, the website 153 comprises a shopping website 153 that sells items and/or services offered by the merchant system 150. In an example, the website 153 communicates transaction details the payment processing system 140 and/or payment application 113 and the payment processing system 140 processes a transaction based on the transaction details and using a payment account selected by the user 101 for use in the transaction.

In an example, the data storage unit 155 comprises a local or remote data storage structure accessible to the merchant system 150 suitable for storing information. In an example, the data storage unit 155 stores encrypted information, such as HTML5 local storage.

In an example, the merchant POS device 157 comprises a user interface, a payment application, a data storage unit, an NFC controller, and an antenna. In an example, the merchant POS device 157 comprises a mobile computing device such as a smartphone device, tablet device, or other mobile computing device. For example, the user interface of the merchant system POS device 157 enables the merchant system POS device 157 operator to interact with the merchant system POS device 157. For example, the user interface may be a touch screen, a voice-based interface, or any other interface that allows the merchant system POS device 157 operator to provide input and receive output from an application on the merchant system POS device 157. In an example, the merchant system POS device 157 operator interacts via the user interface with the payment application operating on the merchant system POS device 157. The payment application may comprise a program, function, routine, applet, or similar entity that exists on and performs its operations on the merchant system POS device 157. In certain examples, the merchant system POS device 157 operator must install the payment application and/or make a feature selection on the merchant system POS device 157 to obtain the benefits of the techniques described herein. In an example, the merchant system POS device 157 operator may access the payment application on the merchant system POS device 157 via the user interface. In an example, the payment application may be associated with the payment processing system 140. In an example, the data storage unit of the merchant system POS device 157 comprises a local or remote data storage structure accessible to the merchant system POS device 157 suitable for storing information. In an example, the data storage unit 135 stores encrypted information, such as HTML5 local storage. In an example, the NFC controller of the merchant system POS device 157 is capable of sending and receiving data, performing authentication and ciphering functions, and directing how the merchant system POS device 157 will listen for transmissions from the user computing device 110 or configuring the merchant system POS device 157 into various power-save modes according to NFC-specified procedures. In another example, the merchant system POS device 157 comprises a Bluetooth controller, Bluetooth low energy (“BLE”) controller, or a Wi-Fi controller capable of performing similar functions. An example NFC controller of the merchant system POS device 157 communicates with the payment application of the merchant system POS device 157 and is capable of sending and receiving data over a wireless, NFC communication channel. In another example, a Bluetooth controller, BLE controller, or Wi-Fi controller performs similar functions as the NFC controller using Bluetooth, BLE, or NFC protocols. In an example, the NFC controller activates an antenna of the merchant system POS device 157 to create a wireless communication channel between the merchant system POS device 157 and the user computing device 110. For example, the merchant system POS device 157 communicates with the user computing device 110 via the antenna of the merchant system POS device 157. In an example, when the merchant system POS device 157 has been activated, the NFC controller of the merchant system POS device 157 polls through the antenna a radio signal, or listens for radio signals from the user computing device 110. In an example, the antenna of the merchant system POS device 157 comprises a means of communication between the merchant system POS device 157 and the user computing device 110. In an example, a NFC controller of the merchant system POS device 157 outputs through the antenna of the merchant system POS device 157 a radio signal, or listens for radio signals from the user computing device 110. In another example, a Bluetooth controller, a BLE controller, or a Wi-Fi controller is used.

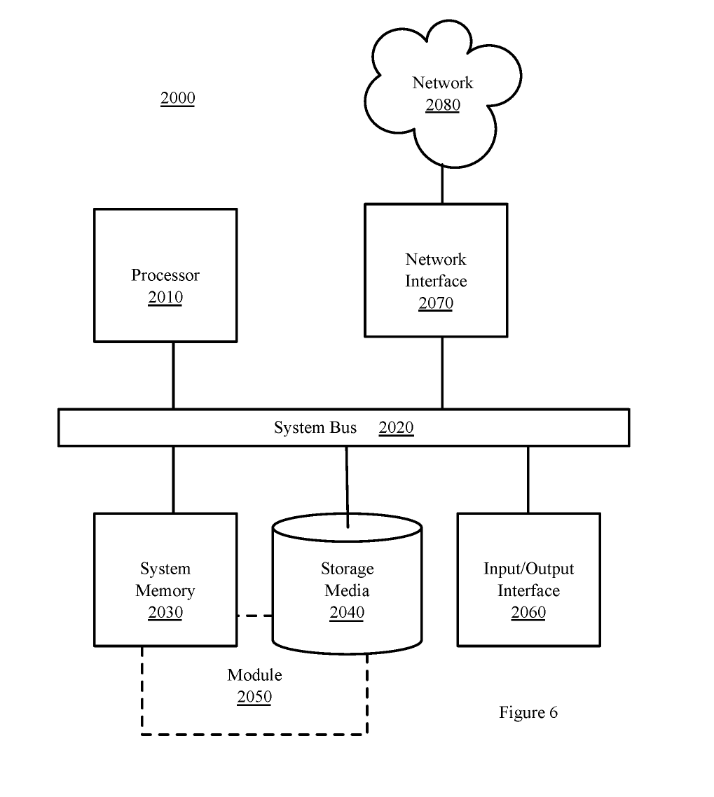

In examples, the network computing devices and any other computing machines associated with the technology presented herein may be any type of computing machine such as, but not limited to, those discussed in more detail with respect to FIG. 6. Furthermore, any functions, applications, or components associated with any of these computing machines, such as those described herein or any others (for example, scripts, web content, software, firmware, hardware, or modules) associated with the technology presented herein may by any of the components discussed in more detail with respect to FIG. 6. The computing machines discussed herein may communicate with one another, as well as with other computing machines or communication systems over one or more networks, such as network 120. The network 120 may include any type of data or communications network, including any of the network technology discussed with respect to FIG. 6.

### Example Processes

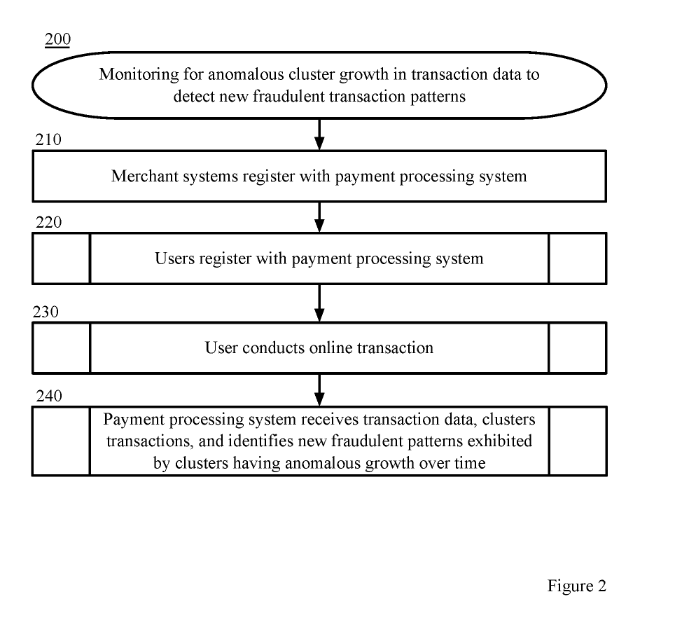

The example methods illustrated in FIGS. 2-5 are described hereinafter with respect to the components of the example operating environment 100. The example methods of FIGS. 2-5 may also be performed with other systems and in other environments. The operations described with respect to any of the FIGS. 2-5 can be implemented as executable code stored on a computer or machine readable non-transitory tangible storage medium (e.g., floppy disk, hard disk, ROM, EEPROM, nonvolatile RAM, CD-ROM, etc.) that are completed based on execution of the code by a processor circuit implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.).

FIG. 2 is a block diagram depicting a method 200 for monitoring for anomalous cluster growth in transaction data to detect new fraudulent transaction patterns, in accordance with certain examples. The method 200 is described with reference to the components illustrated in FIG. 1.

In block 210, merchant systems 150 register with the payment processing system 140. In an example, an agent of a respective merchant system 150 registers for a merchant system 150 account with the payment processing system 140 via a website 153 of the payment processing system 140. In an example, the merchant system website 153 is able to communicate with one or more user computing devices 110, the payment processing system 140, one or more issuer systems 130, and one or more acquirer systems over a network 120. In an example, the merchant system website 153 communicates with the payment processing system 140 over the network 120. In certain examples, the merchant system website 153 may be able to transmit transaction details to the payment processing system 140 via the network 120 to enable the payment processing system 140 to process a transaction.

In another example, a merchant system POS device 157 operator installs a payment application on the merchant system POS device 157 or purchases or otherwise obtains a merchant system POS device 157 from the payment processing system 140. In an example, the merchant system POS device 157 is able to communicate with one or more user computing devices 110, the payment processing system 140, one or more issuer systems 130, and one or more acquirer systems over a network 120. In an example, the merchant system POS device 157 communicates with the payment processing system 140 via the payment application of the merchant system POS device 157 over the network 120. In certain examples, the merchant system POS device 157 may be able to transmit transaction details and a merchant system POS device 157 identifier to the payment processing system 140 via the payment application over the network 120 to enable the payment processing system 140 to process a transaction. In an example, the merchant system POS device 157 is able to receive receipts from the payment processing system 140 that notifies a merchant system POS device 157 operator as to whether a transaction was successful or not. In an example, the merchant system POS device 157 comprises a mobile device, for example, a mobile phone device, a tablet device, or a laptop computing device.

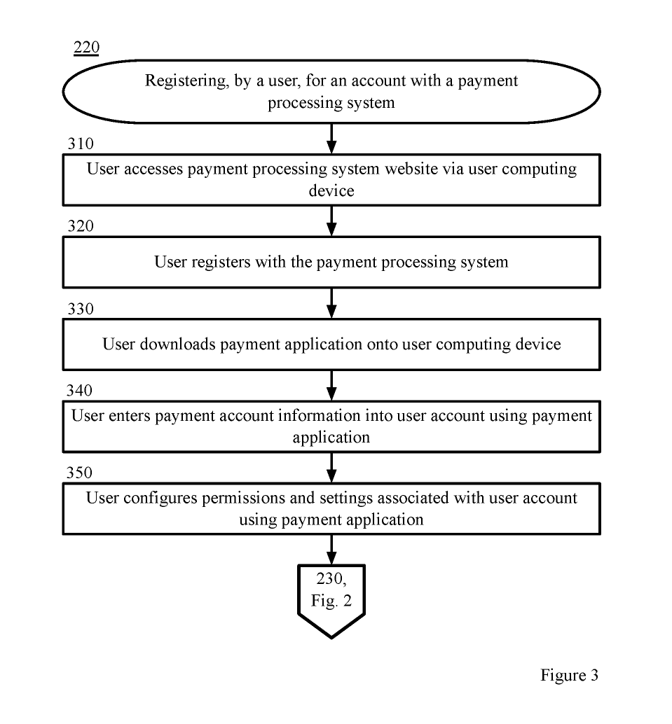

In block 220, users 101 register with the payment processing system 140. The method for registering, by a user 101, for an account with a payment processing system 140 is described in more detail hereinafter with reference to the method described in FIG. 3.

FIG. 3 is a block diagram depicting a method 220 for registering, by a user 101, for an account with a payment processing system 140, in accordance with certain examples. The method 220 is described with reference to the components illustrated in FIG. 1.

In block 310, the user accesses a payment processing system 140 website via the user computing device 110. For example, the user 101 accesses the payment processing system 140 website via a web browser of the user computing device 110. In another example, the user 101 may otherwise contact the payment processing system 140 to register for a user 101 account.

In block 320, the user 101 registers with the payment processing system 140. The user 101 may obtain a user 101 account number, receive the appropriate applications and software to install on the user computing device 110 or perform any action provided by the payment processing system 140. The user 101 may utilize the functions of the user computing device 110, such as the user interface 111 and the web browser 118, to register and configure a user 101 account.

In block 330, the user 101 downloads a payment application 113 onto the user computing device 110. In an example, the payment application 113 operating on the user computing device 110 is able to communicate with the payment processing system 140 over the network 120.

In block 340, the user 101 enters payment account information into the user 101 account using the payment application 113. In an example, the user 101 may enter payment account information associated with one or more user 101 accounts, for example, one or more credit accounts, one or more bank accounts, one or more stored value accounts, and/or other appropriate accounts into the user 101 account maintained by the payment processing system 140.

In block 350, the user 101 configures permissions and settings associated with the user 101 account using the payment application 113. In an example, the user 101 may configure user 101 account settings or add, delete, or edit payment account information via the payment application 113. In an example, the user 101 may select an option to enable or disable the permission of the payment processing system 140 to process transactions.

From block 350, the method 220 proceeds to block 230 in FIG. 2.

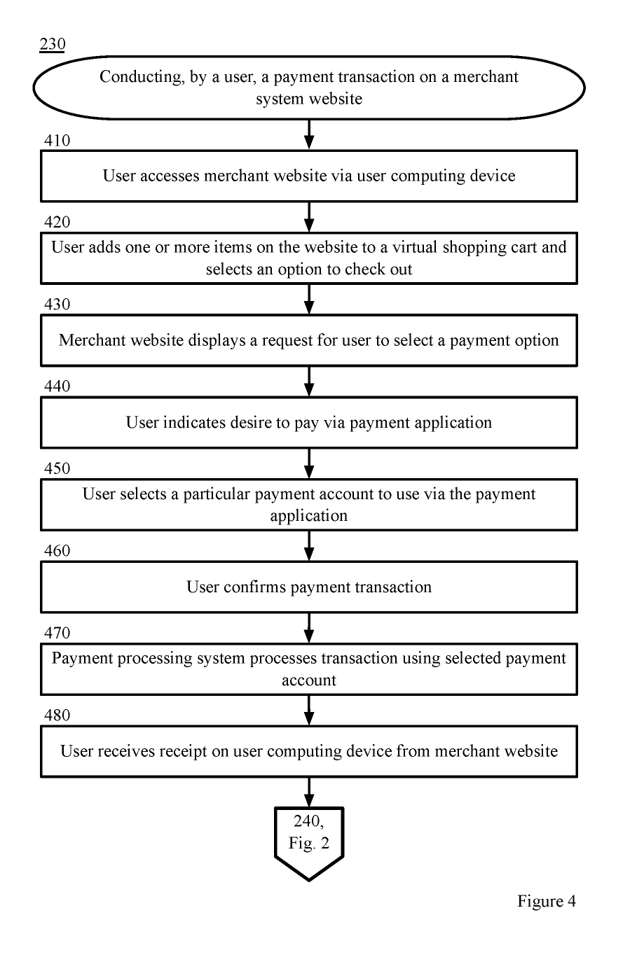

Returning to FIG. 2, in block 230, the user 101 conducts a payment transaction. The method for conducting, by a user 101, a payment transaction is described in more detail hereinafter with reference to the method described in FIG. 4.

FIG. 4 is a block diagram depicting a method 230 for conducting, by a user 101, a payment transaction on a merchant system website 153, in accordance with certain examples. The method 230 is described with reference to the components illustrated in FIG. 1.

In block 410, the user 101 accesses the merchant system website 153 via the user computing device 110. In an example, the user 101 enters the merchant website 153 address into the web browser 118 or otherwise accesses the merchant website 153 via the web browser 118. In an example, the user 101 actuates a user interface 111 object on an advertisement on the web browser 118 and the web browser 118 redirects to the merchant website 153. In another example, the user 101 accesses the merchant system website 153 via a merchant system 150 application (not shown) resident on the user computing device 110 that communicates with the merchant system 150 over the network 120. For example, the user 101 downloads the merchant system 150 application from the merchant system 150 via the network 120.

In block 420, the user 101 adds one or more items on the website 153 to a virtual shopping cart and selects an option to checkout. For example, the user 101 selects one or more products or services on the website 153 via the user interface 111 and adds them to a virtual shopping cart. In an example, the user 101 indicates readiness for payment. For example, the user 101 actuates an object on a user interface 111 to select an option to checkout. In an example, the user 101 enters additional information, such as shipping information, associated with the order.

In block 430, the merchant system website 153 displays a request for the user 101 to select a payment option. In an example, the merchant system website 153 displays payment options that may comprise payments via credit card, financial account, digital wallet, stored value card, and/or coupon. In an example, the merchant website 153 presents one or more user interface 111 objects that the user 101 may actuate via the user computing device 110 to select a payment option.

In block 440, the user 101 indicates a desire to pay via the payment application 113. In an example, the payment application 113 comprises a digital wallet account associated with the payment processing system 140 to which the user 101 has added payment account information associated with one or more payment accounts of the user 101. In an example, the payment application 113 is associated with the user's 101 payment processing system 140 account. In an example, the user 101 account with the payment processing system 140 comprises a digital wallet account. In an example, the payment application 113 is a digital wallet application that communicates with the payment processing system 140 via the network 120. In an example, the user 101 actuates a user interface 111 object to select the payment application 113 payment option. In certain examples, the user 101 may need to sign in to the user 101 account and/or to the payment application 113 to continue with the transaction. For example, the payment application 113 requests a username and password associated with the user 101 account. In another example, the user computing device web browser 118 is redirected to a payment processing system 140 website, wherein the user 101 enters a username and password associated with the user 101 account.

In block 450, the user selects a particular payment account to use via the payment application 113. In an example, in response to the user 101 selecting the payment application 113 as the payment option on the merchant system website 153, the payment application 113 receives a request from the merchant system website 153 for payment account information associated with one or more payment accounts of the user. In this example, the payment application 113 transmits payment account information describing one or more payment accounts of the user 101 to the merchant system website 153 and the merchant system website 153 displays the one or more payment accounts of the user 101 for selection by the user 101. In this example, the payment account information comprises incomplete, occluded, and/or obfuscated payment account information. For the payment account information describing one or more payment accounts of the user 101 may only specify the final four digits of each account number associated with each respective payment account of the user 101. In this example, the user 101 selects a particular payment account for use in the transaction via the merchant system website 153 and the merchant system website 153 communicates, via the network 120, an indication of the selection of the particular payment account to the payment processing system 140 along with transaction details associated with the current transaction. In an example, the user 101 selects a particular displayed payment account for use in the transaction by actuating an interface object displayed on the user interface 111 as a representation of the particular payment account. For example, the merchant system website 153 transmits, to the payment processing system 140 and/or the payment application 113 via the network 120, transaction details comprising merchant system 150 financial account information, overall transaction total, a total amount for the one or more items and/or services purchased, a description of each of the one or more items and/or services purchased, a total shipping amount, and/or a total tax amount for the transaction. In an example, the payment processing system 140 receives the transaction details and the indication of the selection by the user 101 of the particular payment account.

In another example, in response to receiving an indication of the user 101 selecting to pay via the payment application 113, the merchant system website 157 transmits to the payment application 113 and/or the payment processing system transaction details associated with the transaction via the network 120. For example, the merchant system website 153 transmits, to the payment processing system 140 and/or payment application 113 via the network 120, transaction details comprising merchant system 150 financial account information, an overall transaction total, a total amount for the one or more items and/or services purchased, a description of each of the one or more items and/or services purchased, a total shipping amount, and/or a total tax amount for the transaction. In an example, in response to receiving the transaction details associated with the transaction, the payment processing system 140 instructs the payment application 113 to display the one or more payment accounts of the user for selection via the user computing device 110 user interface 111. In another example, the payment application 113 receives the transaction details from the merchant system website 153 over the network 120 and, in response to receiving the transaction details, displays the one or more payment accounts of the user 101 for selection via the user computing device 110 user interface 111. In an example, the user 101 selects a particular displayed payment account for use in the transaction by actuating an interface object displayed on the user interface 111 as a representation of the particular payment account. In this example, the payment application 113 receives an indication of the selection by the user 101 of the particular payment account for use in the transaction.

The payment processing system 140 and/or the payment application 113 may also determine further transaction details by communicating with the merchant system website 153 and/or the user computing device 110, such as an IP address of the merchant system server 151, an IP address of the network 120 device currently being used by the user computing device 110 to access the network 120, a media access control (“MAC”) address of the user computing device 110, a hardware identifier associated with the user computing device 110, or other transaction details obtainable from the user computing device 110 and or the merchant system website 153.

In block 460, the user 101 confirms the payment transaction. In an example, the payment application 113 and/or merchant system website 153 displays a transaction summary for the user 101 and the user 101 reviews the transaction summary. In an example, the payment application 113 displays an object on the user interface 111 of the user computing device 110 indicating an option to proceed with processing the transaction. In an example, the user 101 selects, via the user interface 111, to confirm the option to proceed with processing the transaction. In an example, the payment application 113 receives an indication of a selection by the user 101 of the user interface 111 object indicating a desire to proceed with processing the transaction. In an example, the payment application 113 communicates any transaction details received from the merchant system 153 and/or the user computing device 110 to the payment processing system 140 via the network 120. In an example, the payment processing system 140 and/or the payment application 113 may log further transaction details in addition to the transaction details previously received from the merchant system website 153 and/or the user computing device 110, for example, location data from the user computing device 110 and/or a time stamp corresponding to the time at which the user selected the option to proceed. The payment processing system 140 may request via the network 120 and receive via the network 120 these further transaction details from the user computing device 110.

In block 470, the payment processing system 140 processes the transaction using the selected payment account. In an example, the payment processing system 140 determines, from the received and/or logged transaction details, an issuer system 130 associated with the payment account selected for use by the user 101 in the transaction. In an example, the payment processing system 140 generates a transaction authorization request based on the transaction details and transmits the transaction authorization request to the issuer system 130 via the network 120. For example, the transaction authorization request comprises one or more transaction details such as merchant system 150 payment account information, a total amount of the transaction, and user 101 payment account information associated with the particular payment account selected by the user 101 for use in the transaction. In an example, the issuer system 130 receives, over the network 120, the transaction authorization request from the payment processing system 140 and either approves or denies the transaction authorization request. The issuer system 130 may transmit a notification of approval of the transaction authorization request or a notification of denial of the transaction authorization request to the payment processing system 140 via the network 120. In an example, the payment processing system 130 receives the notification of approval or the notification of denial of the transaction authorization request from the issuer system 130 over the network 120.

In block 480, the user 101 receives a receipt on the user computing device 110 from the merchant system website 157. In an example, the payment processing system 140 generates a receipt based on the notification of approval or the notification of denial of the transaction authorization request received from the issuer system 130 and transmits the receipt to the user computing device 110 over the network 120. In an example, the payment processing system 140, instead of or in addition to transmitting the receipt to the user computing device 110, transmits the receipt to the merchant system 150 via the network 120.

In certain examples, in addition to or instead of users 101 conducting online transactions with a merchant system website 153, users 101 may conduct transactions at merchant system POS devices 157 at respective merchant system 150 locations. For example, the user 101 arrives at the merchant system POS device 157 associated with a merchant system 150 location. In an example, at a time prior to approaching the merchant system POS device 157, the user 101 browses the merchant system 150 location and selects one or more items to purchase. In this example, the user 101 may collect the one or more items and carry, or otherwise transport via physical basket or shopping cart, the one or more items to the merchant system POS device 157. In this example, the user 101 carries or otherwise has in his possession the user computing device 110. In an example, the merchant system POS device 157 operator totals items of the user 101 for purchase. In an example, the merchant system POS device 157 operator scans barcodes associated with the one or more items of the user 101 or otherwise enters information associated with the items into the merchant system POS device 157.

In an example, the merchant system POS device 157 operator asks the user 101 to select a payment option. In an example, the merchant system POS device 157 displays one or more payment options that the user 101 may select to use in a transaction. Example payment options may comprise payment via a payment application of the merchant system POS device 157 associated with the payment processing system 140 with which both the user 101 and the merchant system 150 have an account, payment by cash, payment by check, payment by credit card, payment by debit card, and/or any other means of payment that the merchant system 150 can or is willing to accept for payment from the user 101. In an example, the one or more payment options are displayed as objects on the user interface of the merchant system POS device 157 and are selectable by the merchant system POS device 157 operator in response to the user 101 directing the merchant system POS device 157 operator to make a selection via the user interface of the merchant system POS device 157. In an example, the merchant system POS device 157 operator may ask the user 101 if the user 101 wishes to conduct a transaction using the account of the user 101 associated with the payment processing system 140. In an example, the user 101 indicates a desire to pay via the payment application of the merchant system POS device 157. For example, the user 101 directs the merchant system POS device 157 operator to initiate a transaction via the payment application of the merchant system POS device 157.

In an example, the merchant system POS device 157 operator selects the payment application 133 on the merchant computing device 130 to initiate a transaction. In an example, in response to receiving a verbal request from the user 101 to select the payment application as a payment option, the merchant system POS device 157 operator actuates an object on the user interface of the merchant system POS device 157 corresponding to the payment application as a payment option. In an example, the merchant system POS device 157 generates transaction details and transmits the transaction details to the payment processing system 140 over the network 120. In an example, transaction details comprise a total amount for the transaction and/or a listing of the one or more items being purchased by the user 101. In an example, the transaction details further comprise a merchant system POS device 157 identifier, for example, a media access control (“MAC”) address, hardware identifier, IP address of a network 120 device over which the merchant system POS device 157 has access to the network 120, or other identifier associated with the merchant system POS device 157 or the network 120 connectivity of the merchant system POS device 157. In an example, the merchant system POS device 157 transmits the transaction details to the payment processing system 140 via the network 120.

In an example, the payment processing system 140 receives the transaction details from the merchant system POS device 157 via the network 120. In an example, the payment processing system 140 determines further transaction details such as a current location of the user computing device 110 involved in the transaction and a time stamp associated with a time at which the payment processing system 140 receives the transaction details from the merchant system POS device 157. In an example, the payment processing system 140 generates a transaction authorization request and transmits, via the network 120, the transaction authorization request to an issuer system 130 associated with the payment account selected by the user 101 for use in the transaction. In an example, the transaction authorization request includes the total amount of the transaction associated with the transaction identifier, the merchant system payment account information, and a user 101 payment account identifier associated with the user 101 payment account selected by the user. In an example, the issuer system 130 receives the transaction authorization request via the network 120 and either approves or denies the transaction authorization request. In an example, the issuer system 130 approves the transaction authorization request and transmits, via the network 120, a notice of approval of the transaction authorization request or a notice of denial of the transaction authorization request to the payment processing system 140 and/or the merchant system POS device 157 in accordance with approving or denying the transaction authorization request.

In an example, the payment processing system 140 and/or the merchant system POS device 157 receives a notice of approval of the transaction authorization request from the issuer system 130 via the network and transmits a receipt, via the network 120, to the user computing device 110 indicating that the transaction was successfully completed and comprising the transaction details, information associated with the merchant system payment account used in the transaction, and/or information associated with the user 101 payment account used in the transaction. In another example, the payment processing system 140 and/or the merchant system POS device 157 receives a notice of denial of the transaction authorization request from the issuer system 130 and transmits a receipt, via the network 120, to the user computing device 110 indicating that the transaction authorization was denied. In an example, the user computing device 110 receives, via the network 120, the receipt information indicating a transaction authorization request approval or a transaction authorization request denial and displays all or part of the receipt information via the user interface 111 of the user computing device.

From block 480, the method 230 proceeds to block 240 in FIG. 2.

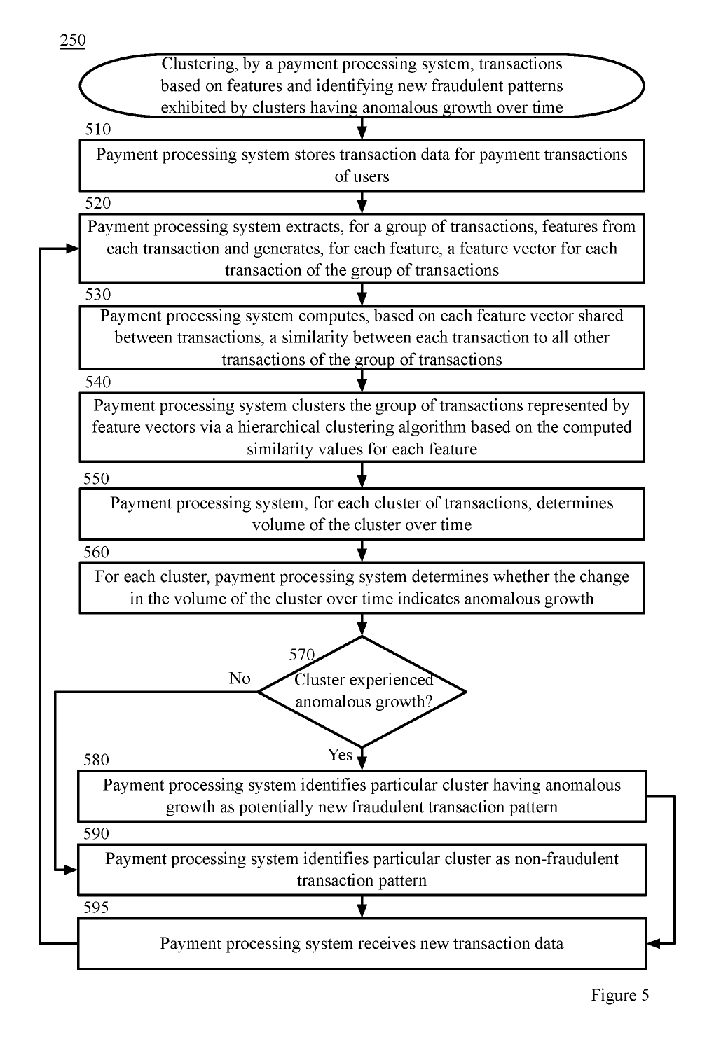

Returning to FIG. 2, in block 240, the paymnet processing system 140 clusters transactions based on features and identifies new fraudulent patterns exhibited by clusters having anomalous growth over time. The method for clustering, by a payment processing system 140, transactions based on features and identifying new fraudulent patterns exhibited by clusters having anomalous growth over time is described in more detail hereinafter with reference to the method described in FIG. 5.

FIG. 5 is a block diagram depicting a method 240 for clustering, by a payment processing system 140, transactions based on features and identifying new fraudulent patterns exhibited by clusters having anomalous growth over time, in accordance with certain examples. The method 240 is described with reference to the components illustrated in FIG. 1.

In block 510, the payment processing system 140 stores transaction data for payment transactions of users 101. For example, the payment processing system 140 stores transaction data for payment transactions of users 101 having user 101 accounts with the payment processing system. In an example, the payment processing system 140 processes online transactions associated with merchant system websites 153. In an example, for an online transaction associated with a merchant website 153, the merchant system website 153 communicates, via the network 120, transaction details to the payment processing system 140. For example, the merchant system website 153 transmits, to the payment processing system 140 and/or the payment application 113 via the network 120, transaction details comprising merchant system 150 financial account information, an overall transaction total, a total amount for the one or more items and/or services purchased, a description of each of the one or more items and/or services purchased, a total shipping amount, and/or a total tax amount for the transaction. In an example, the payment processing system 140 receives the transaction details and an indication of the selection by the user 101 of the particular payment account. In another example, the merchant system website 153 transmits one or more of the transaction details, via the network 120, to the payment application 113 operating on the user computing device 110 of the user 101 conducting the online transaction with the merchant system 150 and the payment application 113 communicates the transaction details to the payment processing system 140 via the network 120. The payment processing system 140 and/or the payment application 113 may also determine further transaction details by communicating with the merchant system website 153 and/or the user computing device 110. For example, further transaction details may comprise an IP address of the merchant system server 151, an IP address of the network 120 device currently being used by the user computing device 110 to access the network 120, a media access control (“MAC”) address of the user computing device 110, a hardware identifier associated with the user computing device 110, or other transaction details obtainable from the user computing device 110 and/or the merchant system website 153. In an example, the payment processing system 140 determines further transaction details such as a current location of the user computing device 110 involved in the transaction and a time stamp associated with a time at which the payment processing system 140 receives the transaction details from the merchant system website 153 by communicating, over the network 120, with the user computing device payment application 113 and/or the merchant system POS device 157.

In an example, the payment processing system 140 processes transactions for merchant systems 150 occurring at merchant system POS devices 157 at merchant system 150 locations. For each transaction processed with a merchant system POS device 157, the merchant system POS device 157 generates transaction details and transmits the transaction details to the payment processing system 140 over the network 120. In an example, transaction details comprise a total amount for the transaction and/or a listing of the one or more items being purchased by the user 101. In an example, the transaction details further comprise a merchant system POS device 157 identifier, for example, a media access control (“MAC”) address, hardware identifier, IP address of a network 120 device over which the merchant system POS device 157 has access to the network 120, or other identifier associated with the merchant system POS device 157 or the network 120 connectivity of the merchant system POS device 157. In an example, the merchant system POS device 157 transmits the transaction details to the payment processing system 140 via the network 120. In an example, the payment processing system 140 receives the transaction details from the merchant system POS device 157 via the network 120. In another example, the merchant system POS device 157 transmits, via the network 120 or a wireless communication channel, the transaction details to the payment application 113 of the user computing device 110 of the user conducting the transaction with the merchant system 150, and the payment application 113 receives the transaction details and transmits the transaction details to the payment processing system 140 via the network 120. In an example, the payment processing system 140 determines further transaction details such as a current location of the user computing device 110 involved in the transaction and a time stamp associated with a time at which the payment processing system 140 receives the transaction details from the merchant system POS device 157 by communicating, over the network 120, with the user computing device payment application 113 and/or the merchant system POS device 157.

In block 520, the payment processing system 140 extracts, for a group of transactions, features from each transaction and generates, for each feature, a feature vector for each transaction of the group of transactions. For example, the group of transactions may comprise all transactions associated with the stored transaction data or a subset of the transactions associated with the stored transaction data. For example, the transactions may comprise online transactions between users 101 and merchant system websites 153 or transactions of users 101 utilizing a user computing device 110 at a merchant system POS device 157. Example features from each transaction comprise one or more of the transaction details received by and/or determined by the payment processing system 140 from merchant system websites 153, merchant system POS devices 157, and/or user computing device payment applications 113. Further, example features from each transaction may comprise one or more characteristics of a user 101 payment processing system 140 account used in the transaction.

For each transaction of the group of transactions, the features may comprise one or more of a total amount of the transaction, a type of payment account used in the transaction, a timestamp associated with the time at which transaction details were received to process the payment transaction, an amount spent by the user 101 using the payment processing system 140 account of the user 101 during a predefined time period prior to the current time, and a distance between a location determined from the internet protocol (“IP”) address of the network 120 device being used by the user computing device 110 to access the network 120 during the transaction and an IP address of the merchant system 150 server 151 or network 120 device used by the merchant POS device 157 to access the network 120 during the transaction. For each transaction of the group of transactions, the features may also comprise one or more of an identifier associated with the merchant POS device 157, an identifier associated with the merchant system website 153, an identifier associated with the user computing device 110, location data logged by the user computing device 110 at the time of the transaction, location data associated with the merchant system POS device 157, and location data associated with the merchant system server 151. For each transaction of the group of transactions, the features may also comprise one or more of an age of the user 101 payment processing system 140 account, a time since the last transaction occurring before the current transaction involving the user 101 payment processing system 140 account, an age of the merchant system 150 payment processing system 140 account, a time since the last transaction occurring before the current transaction involving the merchant system 150 payment processing system 140 account, an identifier associated with an issuer system 130 that approved or denied a transaction authorization request associated with the transaction, and other transaction features determined by the payment processing system 140. For each transaction of the group of transactions, the features may comprise one or more of a number of payment accounts that have been added to the user payment processing system 140 account, a number of user payment accounts in the user 101 payment processing system 140 account associated with the same social security number as the payment account used in the current transaction, a Gibberish score or other measure of meaningfulness of a user 101 email address, a shift of internet protocol (“IP”) addresses in a recent trace of the user 101 payment account, and a classification of the internet protocol address used in the current transaction as a public IP address, data center IP address, educational system IP address, or private IP address.

Example feature vectors for each transaction of the group of transactions comprise vectors representing each feature of a respective transaction represented in a feature space. The feature space may comprise a number of dimensions corresponding to the number of features being analyzed by the payment processing system 140 for the transaction and the payment processing system 140 may construct a feature vector for each feature for each transaction of the group of transactions in the feature space. In an example, a feature vector comprises a numerical value corresponding to the particular feature associated with the feature vector. For example, the feature of the age of the user 101 payment processing system 140 account, a first feature vector associated with a first transaction comprises a numerical value of 550 days and a second feature vector associated with a second transaction comprises a numerical value of 20 days. In an example, the payment processing system 140 maps each transaction in the feature space based on the feature vectors of each transaction.

In an example, the payment processing system 140 determines three features for each transaction of the group of transactions comprising an age of user 101 account, a total amount of the transaction, and a distance between locations associated with the IP addresses of the merchant server 151 and the network 120 device used by the user computing device 110 to access the network 120 during the transaction. In this example, the group of transactions comprises three transactions, the feature vectors of transaction 1 comprising (550 days, $290, 30 km), transaction 2 comprising (20 days, $4, 10,000 km), and transaction 3 comprising (200 days, $50, 50 km). In this example, each transaction may be mapped in the feature space and in this example, the feature space would comprise three dimensions corresponding to the three common features being analyzed for each transaction. In this example, in the dimension of feature space corresponding to the age of the user 101 account, transaction 1 would be mapped 350 units away from transaction 3 and 530 units away from transaction 2, where the units in this particular dimension of the feature space represent days. However, in this example, in the dimension of feature space corresponding to the total amount of the transaction, transaction 1 would be mapped 240 units away from transaction 3 and 286 units away from transaction 2, where the units in this particular dimension of feature space represent a dollar amount corresponding to the total amount of the transaction. The payment processing system 140 may use any number of common features for any number of transactions and map each transaction within a feature space comprising a number of dimensions corresponding to the number of common features between the number of transactions. In certain examples, if a transaction does not have a value for a feature corresponding to a feature of one or more other transactions, the payment processing system 140 assigns a default value for the feature for the transaction.

In block 530, the payment processing system 140 computes, based on each feature vector shared between transactions, a similarity value between each transaction to all other transactions in the group of transactions. In an example, the similarity value may correspond to a distance between each transaction to each of the other transactions in a particular dimension of feature space corresponding to a particular common feature for the group of transactions. In another example, the similarity value may correspond to a distance between each transaction to each of the other transactions in a particular two or more dimensions of feature space corresponding to a particular two or more common features for the group of transactions. In yet another example, the similarity value may correspond to an overall distance between each transaction to each of the other transactions in all dimensions of feature space corresponding to all common features for the group of transactions. In an example, similarity values may be calculated as distances within feature space between two transactions and then the distances may be divided by a common factor to produce similarity values between 0 and 1, where 0 representing a longest distance between two transactions and 1 representing transactions identical within the feature space corresponding to the features being analyzed for the group of transactions. Distances between transactions in feature space may be calculated using Euclidean distance, cosine distance, or Hamming distance, or other appropriate mathematical method. In certain examples, if units associated with the transactions for one or more particular dimensions are not consistent, the payment processing system 140 normalizes feature values in each dimension by either a linear transformation and/or a fractional ranking.

In block 540, the payment processing system 140 clusters the group of transactions represented by feature vectors via a hierarchical clustering algorithm based on the computed similarity values for each feature. In another example, the payment processing system 140 clusters the group of transactions represented by feature vectors via a hierarchical clustering algorithm based on the computed similarity values for each feature or combination of features. In an example, the payment processing system 140 determines one or more thresholds corresponding to similarity values associated with a first feature or a first combination of features. For example, the payment processing system 140 determines to divide transactions into 5 clusters based on the first feature or the first combination of features. For example, for a particular first feature, where similarity values correspond to values between 0 and 1, the payment processing system 140 determines thresholds corresponding to 0.2, 0.4, 0.6, and 0.8 and clusters the transactions into a first cluster corresponding to similarity values between 0-0.2, a second cluster corresponding to similarity values between 0.2-0.4, a third cluster corresponding to similarity values between 0.4-0.6, a fourth cluster corresponding to similarity values between 0.6-0.8, and a fifth cluster corresponding to similarity values between 0.8-1.0. The payment processing system 140 may adjust the assignment of thresholds between transaction clusters for the first feature or first combination of features until the sum of the similarity values among transactions in each cluster reaches an overall maximum threshold similarity value. In this example, the payment processing system 140 further analyzes each of these clusters and divides the clusters into sub-clusters based on similarity values of each transaction corresponding to a second feature, and then further divides the sub-clusters into further clusters based on similarity values for each transaction corresponding to a third feature, and so on.

In block 550, the payment processing system 140, for each cluster of transactions, determines a volume of the cluster over time. In an example, transaction clusters may correspond to clusters determined based on similarity values corresponding to one feature or sub-clusters determined based on similarity values corresponding to two or more features. The payment processing system 140, determines, for each transaction time stamp data corresponding to when the transaction was processed. For example, the time stamp data may correspond to a time stamp logged by the payment processing system 140 when receiving a request to process the transaction from a merchant system website 153, from a merchant system POS device 157, or from a user computing device 110. For each cluster, the payment processing system 140 may determine a number of transactions that fall within the cluster between one or more intervals of time determined based on the time stamp data corresponding to each transaction. For example, the intervals may be hourly, daily, by the minute, by the week, by the month, or by any appropriate length of time.

In block 560, the payment processing system 140 determines whether the change in volume of the cluster over time indicated anomalous growth. The payment processing system 140 may use one or more statistical methods to determine whether a growth rate is anomalous. For example, the payment processing system 140 may graph the time interval against the volume and determine the percentage change in volume between each interval. For example, for each interval, the payment processing system 140 subtracts the volume of the preceding interval from the volume of the interval and divides by the volume of the previous interval and multiplies by 100 to determine a percentage increase in the volume between the previous interval and the current interval. In this example, the payment processing system 140 determines a threshold percentage volume increase and if the percentage volume increase for any of the intervals is greater than the threshold, the payment processing system 140 determines that the cluster experienced anomalous growth. For example, the threshold percentage comprises 3%, 30%, 500%, or 1000%. A lower threshold for the percentage volume increase may result in too many transaction clusters being erroneously determined as having anomalous growth while a higher threshold for the percentage volume increase may result in mislabeling the growth of the cluster as anomalous. In an example, determining anomalous growth may further require the percentage volume increase to maintain a value over the threshold for a certain number of time intervals or require the volume at each successive interval after the first interval surpassing the threshold percentage change in volume to maintain an equal or greater value to the volume of the first interval.

In block 570, the payment processing system 140, the payment processing system 140 determines if a particular cluster experienced anomalous growth based on the volume of the particular cluster over time.

If the particular cluster experienced anomalous growth, the method 240 proceeds to block 580. For example, for a particular cluster of transactions the volume of the cluster on days 1, 2, 3, 4, 5, 6, 7, 8, 9, and 10 correspond to 20 transactions on day 1, 15 transactions on day 2, 33 transactions on day 3, 24 transactions on day 4, 19 transactions on day 5, 26 transactions on day 6, 29 transactions on day 7, 190 transactions on day 8, and 250 transactions on day 9, and 500 transactions on day 10. In this example, the payment processing system 140 determines that a cluster experiences anomalous growth if, during an interval of time, the cluster experiences growth more than 100% at a particular interval and then maintains an equal or greater volume for two successive intervals. In this example, the volume of the number of daily transactions begins to change drastically between days 7 and 8, with a percentage volume increase of (190−29)/29×100=555% and then maintains a volume greater than 190 (corresponding to day 8) for days 9 and 10, satisfying the conditions for classification of the cluster as having “anomalous growth.”

In block 580, the payment processing system identifies the cluster having anomalous growth as a potentially new fraudulent transaction pattern. In an example, the payment processing system 140 generates a report describing features of the cluster comprising anomalous growth. For example, the payment processing system 140 may determine a value or range of values for each feature of the cluster. For example, the cluster comprising anomalous growth comprises transactions for a total amount of $26.99, made between 5-6 p.m. Eastern Standard Time, comprising an IP address of the user computing device from a particular location. In another example, the cluster comprises transactions having a total amount of $200˜250, that are paid by a bank account with a particular type of verification, and wherein the user provided a social security number to the payment processing system within three days of the transaction, and wherein the user 101 never had paid money to the same merchant system associated with the transaction before. In an example, the payment processing system 140 analyses transaction data associated with each transaction in the cluster having anomalous growth to determine whether the transaction is fraudulent. Determining whether the transaction is fraudulent may comprise contacting the user 101, merchant system 150, or issuer system 130 associated with the transaction to request information. In another example, the payment processing system 140 designates one or more transactions in the cluster comprising anomalous growth as being potentially fraudulent and may notify the user 101 associated with the respective transaction that the transaction is potentially fraudulent. For example, in response to determining the cluster comprising anomalous growth, the payment processing system 140 designates the cluster comprising anomalous growth as a fraudulent transaction cluster and notifies, for each transaction in the fraudulent transaction cluster, a user 101 or merchant system 150 associated with each transaction that the transaction is potentially fraudulent. In this example, the payment processing system 140 transmits the notification that the transaction is potentially fraudulent to a user computing device 110 associated with the user 101 or to the merchant system 150 via the network 120. In an example, the payment processing system 140 generates a report comprising a description of clusters, classifying each cluster as either having anomalous growth or non-anomalous growth.

In block 595, the payment processing system 140 receives new transaction data. In an example, the payment processing system 140 at a time after receiving the transaction data, receives subsequent transaction data. In an example, the subsequent transaction data comprises all, part, or none of the transaction data plus new transaction data associated with one or more online transactions of users 101 with merchant system websites 153 or at merchant system POS devices 157. In an example, the payment processing system 140 performs the example method described in blocks 510-590 with the subsequent transaction data by analyzing the transaction data to extract features, mapping the transactions in virtual space and determining similarity values between transactions, and clustering the transactions into clusters based on similarity, determining a volume over time for each cluster, and identifying clusters comprising anomalous growth in volume over time.

Returning to block 570, if the particular cluster did not experience anomalous growth, the method 240 proceeds to block 590.

In block 590 the payment processing system 140 identifies the particular cluster as a non-fraudulent transaction pattern. In an example, the payment processing system 140 generates a report comprising a description of clusters, classifying each cluster as either having anomalous growth or non-anomalous growth.

In block 595, the payment processing system 140 receives new transaction data. In an example, the payment processing system 140 at a time after receiving the transaction data, receives subsequent transaction data. In an example, the subsequent transaction data comprises all, part, or none of the transaction data plus new transaction data associated with one or more online transactions of users 101 with merchant system websites 153 or at merchant system POS devices 157. In an example, the payment processing system 140 performs the example method described in blocks 510-590 with the subsequent transaction data by analyzing the transaction data to extract features, mapping the transactions in virtual space and determining similarity values between transactions, and clustering the transactions into clusters based on similarity, determining a volume over time for each cluster, and identifying clusters comprising anomalous growth in volume over time.

### OTHER EXAMPLES

In an example, merchant systems register with an application distribution system. Users register with the application distribution system. Each user registers with the application distribution system by accessing, via a respective user computing device, an application distribution system website, registering with the application distribution system via the application distribution system website, and downloading a browsing application onto the respective user computing device. Each user can submit reviews for one or more of the one or more applications managed by the application distribution system via the browsing application. Each user may read reviews for one or more of the one or more applications managed by the application distribution system via the browsing application. Further, each user may download one or more of the one or more applications managed by the application distribution system via the browsing application. Users submit reviews for applications, using respective user computing devices. A user submitting a review of a particular application selects, via the user computing device, a particular application managed by the application distribution system for review. The user may input numerical values using the user interface of the user computing device and/or submit text and then select an object on the user interface of the user device to submit the review. The application distribution system receives user review data comprising one or more user reviews associated with one or more particular applications and extracts, for each user review, features from each user review and generates, for each feature, a feature vector representing each user review of the group of user reviews. The application distribution system computes, for each feature vector shared between user reviews, a similarity between each user review and all other user reviews of the group of user reviews. The application distribution system clusters the user reviews represented by the feature vectors via a hierarchical clustering algorithm based on the similarity values. The application distribution system, for each cluster of user reviews, determines a volume of the cluster over time. For each cluster, the application distribution system determines whether the change in the volume of the cluster over time is anomalous or normal. For each cluster, if the cluster experienced anomalous growth, the application distribution system identifies the cluster as a potential new fraudulent user review pattern. For each cluster, if the cluster did not experience anomalous growth, the application distribution system identifies the cluster as a non-fraudulent user review pattern. The application distribution system receives new user review data at a subsequent time and performs the method for clustering user reviews based on features and determining anomalous cluster growth.

In another example, users register for accounts with an electronic mail (“e-mail”) distribution system. Each user registers with the e-mail distribution system by accessing, via a respective user computing device, an e-mail distribution system website, registering with the e-mail distribution system via the e-mail distribution system website, and downloading an e-mail application onto the respective user computing device. Each user can send one or more e-mails via the e-mail application or via a website of the e-mail distribution system. Each user may compose e-mails via the e-mail application or via the website of the e-mail distribution system. Further, each user may send e-mails via the e-mail application or via the website of the e-mail distribution system to one or more users having accounts with the e-mail distribution system and/or to users having accounts with one or more other e-mail distribution systems. Each user may receive e-mails via the e-mail application or via the website of the e-mail distribution system from one or more users having accounts with the e-mail distribution system and/or from users having accounts with one or more other e-mail distribution systems. E-mails may comprise text, images, files, videos, and/or other data. The e-mail distribution system receives e-mail data comprising one or more e-mails sent and/or received by the users of the e-mail distribution system and extracts, for each e-mail, features from each e-mail and generates, for each e-mail, a feature vector representing each e-mail of the group of e-mails. The e-mail distribution system computes, for each feature vector shared between e-mails, a similarity between each e-mail and all other e-mails of the group of e-mails. The e-mail distribution system clusters the e-mails represented by the feature vectors via a hierarchical clustering algorithm based on the similarity values. The email distribution system, for each cluster of e-mails, determines a volume of the cluster over time. For each cluster, the e-mail distribution system determines whether the change in the volume of the cluster over time is anomalous or normal. For each cluster, if the cluster experienced anomalous growth, the e-mail distribution system identifies the cluster as a potential new fraudulent e-mail pattern. For example, a fraudulent e-mail pattern may be considered a “spam e-mail” pattern or “junk e-mail” pattern by the e-mail distribution system. For each cluster, if the cluster did not experience anomalous growth, the e-mail distribution system identifies the cluster as a non-fraudulent e-mail pattern. For example, the e-mail distribution system may mark each e-mail in the anomalous growth cluster as “spam” or “junk” in the inbox of the respective destination user account or otherwise categorize the e-mail as a “spam” email or “junk” email. The e-mail distribution system receives new e-mail data at a subsequent time and performs the method for clustering e-mails based on features and determining anomalous cluster growth.

In yet another example, users register for accounts with an account management system that provides one or more services to users. Each user registers with the account management system by accessing, via a respective user computing device, an account management system website, registering with the account management system via the account management system website, and downloading a service application onto the respective user computing device. Each user can submit one or more service requests via the service application or via the website of the account management system. A service request may comprise a request for information or a submission of information from the user to the account management system. Each user may configure login information comprising a user name, password, and/or other login credentials. Users may login to their respective accounts using their respective login information. When users attempt to login to their respective accounts, the account management system logs a record of each login attempt. The account management system extracts and/or receives account login data comprising one or more login attempt records and generates, for each login attempt record, a feature vector representing each login attempt record of the group of login attempt records. The account management system computes, for each feature vector shared between login attempt records, a similarity between each login attempt record and all other login attempt records of the group of login attempt records. The account management system clusters the login attempt records represented by the feature vectors via a hierarchical clustering algorithm based on the similarity values. The account management system, for each cluster of login attempt records, determines a volume of the cluster over time. For each cluster, the account management system determines whether the change in the volume of the cluster over time is anomalous or normal. For each cluster, if the cluster experienced anomalous growth, the account management system identifies the cluster as a potential new fraudulent login attempt pattern. For example, a fraudulent login attempt pattern may be considered a login attack pattern by the account management system. For example, fraudsters may develop automation scripts that make brute-force attempts to login to user service accounts. For each cluster, if the cluster did not experience anomalous growth, the account management system identifies the cluster as a non-fraudulent login attempt pattern. For example, the account management system may contact the user associated with each service account corresponding to each login attempt record associated with the anomalous cluster to suggest that the user change his or her password, username, or other login credentials associated with the respective service account. The account management system extracts and/or receives new login attempt record data at a subsequent time and performs the method for clustering login attempt records based on features and determining anomalous cluster growth.

### Other Examples

FIG. 6 depicts a computing machine 2000 and a module 2050 in accordance with certain examples. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a router or other network node, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to certain examples, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with an opportunity or option to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The examples described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different examples, and/or certain additional acts can be performed, without departing from the scope and spirit of various embodiments. Accordingly, such alternative embodiments are included in the scope of the following claims, which are to be accorded the broadest interpretation so as to encompass such alternate embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the examples, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method to determine features associated with fraudulent transactions, comprising:
retrieving, by one or more computing devices, transaction data corresponding to a group of transactions processed by the one or more computing devices;
for each transaction of the group of transactions:
extracting, by the one or more computing devices and from the transaction data, data associated with one or more features of the transaction;
determining, by the one or more computing devices, a feature vector associated with each feature of the one or more features of the transaction; and
for each particular feature shared by the transaction with one or more other transactions of the group of transactions, determining, by the one or more computing devices, a similarity between the transaction and the one or more other transactions of the group of transactions based on the respective feature vector associated with the particular feature for the transaction and each of the respective feature vectors associated with the particular feature for the one or more other transactions of the group of transactions;
clustering, based on the similarity values determined for each particular feature vector of each transaction of the group of transactions, the group of transactions to generate one or more transaction clusters;
determining, from the transaction data and for each transaction, by the one or more computing devices, time stamp data;
determining, based on the time stamp data and by the one or more computing devices, a volume of each transaction cluster over time. determining, by the one or more computing devices, that a rate of change of a volume of a particular transaction cluster over time exceeds a specified rate of change;
in response to determining that the rate of change of the particular transaction cluster volume over time exceeds the specified rate of change, identifying, by the one or more computing devices, the transaction cluster as a fraudulent transaction cluster; and
in response to identifying the transaction cluster as a fraudulent transaction cluster, transmitting, by the one or more computing devices for each transaction in the particular transaction cluster to a user computing device, a notification to a user computing device associated with a user associated with the transaction that the transaction may comprise a potentially fraudulent transaction.

2. The method of claim 1, wherein the group of transactions are clustered via a hierarchical clustering algorithm to generate one or more transaction clusters.

3. The method of claim 1, wherein the group of transactions comprises one or more online transactions with one or more websites associated with one or more respective merchant systems.

4. The method of claim 1, wherein the one or more features comprise one or more of a total amount of the transaction, an age of an account associated with the user in the transaction, a type of payment instrument used in the transaction, a date of the most recent transaction approved prior to the transaction, an amount spent over a period of time by the user, and a distance between a device of the merchant system used in the transaction and a device of the user used in the transaction.

5. The method of claim 1, further comprising:
for each transaction of the group of transactions:
mapping the transaction in virtual space comprising a number of dimensions corresponding to a number of features, based on the feature vector associated with each feature of the one or more features of the transaction,
wherein the similarity between the transaction and the one or more other transactions of the group of transactions is determined further based on a distance in the virtual space between the transaction and the one or more other transactions of the group of transactions.

6. The method of claim 1, wherein determining the volume of each transaction cluster over time comprises determining the volume of each transaction cluster over time over one or more time intervals.

7. The method of claim 6, wherein determining that the rate of change of the volume of the particular transaction cluster over time exceeds the specified rate of change of volume over a predefined number of time intervals.

8. A computer program product, comprising:
a non-transitory computer-readable medium having computer-executable program instructions embodied thereon that when executed by one or more computing devices cause the one or more computing devices to detect fraudulent transactions, the computer-executable program instructions comprising:
computer-executable program instructions to retrieve transaction data corresponding to a group of transactions processed by the one or more computing devices;
for each transaction of the group of transactions:
computer-executable program instructions to extract, from the transaction data, data associated with one or more features of the transaction;
computer-executable program instructions to determine a feature vector associated with each feature of the one or more features of the transaction; and
for each particular feature shared by the transaction with one or more other transactions of the group of transactions, computer-executable program instructions to determine a similarity between the transaction and the one or more other transactions of the group of transactions based on the respective feature vector associated with the particular feature for the transaction and each of the respective feature vectors associated with the particular feature for each of the one or more other transactions of the group of transactions;
computer-executable program instructions to cluster, based on the similarity determined for each particular feature vector of each transaction of the group of transactions, the group of transactions to generate one or more transaction clusters;
computer-executable program instructions to determine, from the transaction data and for each transaction, time stamp data;
computer-executable program instructions to determine, based on the time stamp data, a volume of each transaction cluster over time.
computer-executable program instructions to determine that a rate of change of a volume of a particular transaction cluster over time exceeds a specified rate of change; and
in response to determining that the rate of change of the particular transaction cluster volume over time exceeds the specified rate of change, computer-executable program instructions to identify that the transaction cluster comprises a fraudulent transaction cluster.

9. The computer program product of claim 8, wherein the group of transactions are clustered via a hierarchical clustering algorithm to generate one or more transaction clusters.

10. The method of claim 8, wherein the group of transactions comprise one or more online transactions with one or more websites associated with one or more respective merchant systems.

11. The computer program product of claim 8, wherein the one or more features comprise one or more of a total amount of the transaction, an age of an account associated with the user in the transaction, a type of payment instrument used in the transaction, a date of the most recent transaction approved prior to the transaction, an amount spent over a period of time by the user, and a distance between a device of the merchant system used in the transaction and a device of the user used in the transaction.

12. The computer program product of claim 8, further comprising:
for each transaction of the group of transactions:
computer-executable program instructions to map the transaction in virtual space comprising a number of dimensions corresponding to a number of features, based on the feature vector associated with each feature of the one or more features of the transaction,
wherein the similarity between the transaction and the one or more other transactions of the group of transactions is determined further based on a distance in the virtual space between the transaction and the one or more other transactions of the group of transactions.

13. The computer program product of claim 8, wherein determining the volume of each transaction cluster over time comprises determining the volume of each transaction cluster over time over one or more time intervals.

14. The computer program product of claim 8, wherein determining that the rate of change of the volume of the particular transaction cluster over time exceeds the specified rate of change of the volume over a predefined number of time intervals.

15. A system to detect fraudulent transactions, comprising:
a storage device; and
a processor communicatively coupled to the storage device, wherein the processor executes application code instructions that are stored in the storage device to cause the system to:
for each transaction of a group of transactions for which the system comprises transaction data:
extract, from the transaction data, data associated with one or more features of the transaction;
determine a feature vector associated with each feature of the one or more features of the transaction; and
for each particular feature shared by the transaction with one or more other transactions of the group of transactions, determine a similarity between the transaction and the one or more other transactions of the group of transactions based on the respective feature vector associated with the particular feature for the transaction and each of the respective feature vectors associated with the particular feature for the one or more other transactions of the group of transactions;
cluster, based on the similarity values determined for each particular feature vector of each transaction of the group of transactions, the group of transactions to generate one or more transaction clusters;
determine, from the transaction data and for each transaction, time stamp data;
determine, based on the time stamp data, a volume of each transaction cluster over time.
determine that a rate of change of a volume of a particular transaction cluster over time exceeds a specified rate of change; and
in response to determining that the rate of change of the particular transaction cluster volume over time exceeds the specified rate of change, identify that the transaction cluster comprises a fraudulent transaction cluster.

16. The system of claim 15, wherein the processor is further configured to execute application code instructions that are stored in the storage device to cause the system to :
retrieve transaction data corresponding to a group of transactions processed by the one or more computing devices; and
store the transaction data corresponding to the group of transactions processed by the one or more computing devices.

17. The system of claim 15, wherein the processor is further configured to execute application code instructions that are stored in the storage device to cause the system to:
for each transaction of the group of transactions:
map the transaction in a virtual space comprising a number of dimensions corresponding to a number of features based on the feature vector associated with each feature of the one or more features of the transaction,
wherein the similarity between the transaction and the one or more other transactions of the group of transactions is determined further based on a distance in the virtual space between the transaction and the one or more other transactions of the group of transactions.

18. The system of claim 15, wherein the one or more features comprise one or more of a total amount of the transaction, an age of an account associated with the user in the transaction, a type of payment instrument used in the transaction, a date of the most recent transaction approved prior to the transaction, an amount spent over a period of time by the user, and a distance between a device of the merchant system used in the transaction and a device of the user used in the transaction.

19. The system of claim 15, wherein determining the volume of each transaction cluster over time comprises determining the volume of each transaction cluster over time over one or more time intervals.

20. The system of claim 19, wherein determining that the rate of change of the volume of the particular transaction cluster over time exceeds the specified rate of change of the volume over a predefined number of time intervals.
